(19) United States
(12) Patent Application Publication
(10) Pub. No.: US 2005/0044145 A1
(43) Pub. Date: Feb. 24, 2005

(54) Collaboration method and system

(75) Inventors: William M. Quinn, Lexington, KY (US); Kevin Solie, Lexington, KY (US); Matthew A. Levy, Winchester, KY (US); James S. Johnston, Lexington, KY (US)

Correspondence Address: RICHARD M. GOLDMAN, 371 ELAN VILLAGE LANE, SUITE 208, CA, 95134, US

(73) Assignee: International Business Machines Corporation

(21) Appl. No.: 10/644,170

(22) Filed: Aug. 20, 2003

(51) Int. Cl. G06F 15/16

(52) U.S. Cl. 709/205

(57) ABSTRACT

A method, system, and program product for collaborative operations on a data structure. The system includes a server and a plurality of clients connected to the server. In one embodiment, the server is configured and controlled for Document Object Model access to and manipulation of mark-up language files. The client is configured and controlled to operate on data structures on a remote work station; invoke a container for the changes to the data structure; encapsulate the operations on the data structure into the container; and send the encapsulated changes to the server. The server is configured and controlled to enter the changes in the data structure, for example, in accordance with the Document Object Model; and to reflect the entered changes to other clients connected to the server.

### FIELD OF THE INVENTION

The invention described herein relates to systems, methods, and program products where shared data are concurrently and collaboratively created and modified by multiple users at multiple workstations, in near real-time, using a server (or collection of servers) to facilitate the synchronization.

### BACKGROUND

Various collaboration systems exist today, including Lotus Sametime, various web conferencing solutions and augmented instant messaging solutions. While the various collaboration systems use many standard protocols and APIs, each collaboration system is a unique product, and while they all share some common technical problems, each of them has its own issues, and each of them has a unique, frequently proprietary, programming model. This drives up costs of development.

Thus, a clear need exists for a collaboration system that utilizes common, pre-existing protocols and APIs to support the modification of a standards compliant shared data structures.

### SUMMARY OF THE INVENTION

The method, system, and program product of our invention provides a collaboration system that utilizes common, pre-existing protocols and APIs to support the modification of a standards compliant data structure or file in substantially real time. Specifically, the method, system, and program product provides for collaborative operations on data and data structures. The system includes a server and a plurality of clients connected to the server. The data structure is a shared data structure, for example, a shared mark-up language file, that is stored on the server. The server is configured and controlled for Document Object Model access to and manipulation of the shared data structures, for example, shared mark-up language files, transient data structures, or stored data structures. The client is configured and controlled to operate on the data structures, such as documents or other files, on a remote work station; invoke a wrapper for the changes to the data structure; wrap or encapsulate the operations on the data structure into the wrapper; and send the wrapped or encapsulated changes to the server. The server is configured and controlled to enter the changes in the data structure in accordance with standard protocols, such as the Document Object Model; and to reflect the entered changes to other clients connected to the server.

The method, system, and program product of our invention utilizes common, pre-existing APIs to support modification of a data structure. As application features invoke the APIs, the modifications are communicated to all associated files and representation of the data and data structures on different workstations, with the shared data structure and DOM method, system, and program product of our invention synchronizing the modifications in a uniform fashion. This is accomplished along with managing multipoint communication, synchronized data transfer, optimized data transfer, and version compatibility.

New, real time collaboration can be created using XML documents to encapsulate the shared properties of the features.

### Definitions

XML (Extensible Markup Language) as used herein means the formal recommendation from the World Wide Web Consortium for a flexible way to create common information formats and share both the format and the date, e.g., on the World Wide Web, intranets, and elsewhere. XML itself is similar to HTML the language of today's Web pages, the Hypertext Markup Language. Both XML and HTML contain markup symbols to describe the contents of a page or file. HTML, however, describes the content of a Web page (mainly text and graphic images) only in terms of how it is to be displayed and interacted with, while XML describes the content in terms of what data is being described. For example, the word “phone_num” placed within markup tags could indicate that the data that followed was a phone number. This means that an XML file can be processed purely as data by a program or it can be stored with similar data on another computer or, like an HTML file, it can be displayed. For example, depending on how the application in the receiving computer wanted to handle the phone number, it could be stored, displayed, or dialed. XML is “extensible” because, unlike HTML, the markup symbols are unlimited and self-defining.

“DOM” as used herein means the Document Object Model programming interface specification developed by the World Wide Web Consortium, which facilitates creating and modifying XML files by an end user. An XML file is an XML document stored as text. As program objects, such documents are able to have their contents and data contained within the object, and documents can carry with them the object-oriented procedures called “methods.” The Document Object Model offers two levels of interface implementation: DOM Core, which supports XML and is the base for the next level, and DOM HTML, which extends the model to HTML documents. Within DOM any HTML or XML element is individually addressable by programming. DOM itself is language-independent, and can be described using a generic interface definition language

“Wrapper” as used herein means an object oriented programming construct for storing and moving objects, as data and methods, and for adding functionalities to an object without changing its data type. Wrappers delegate function calls to the objects that they are calling.

“Markup language” as used herein means languages with sequences of characters or other symbols that are inserted at certain places in a text or word processing file to indicate how the file should look when it is printed or displayed, or to describe the document's logical structure, or document metadata. The markup indicators are often called “tags.”

“Collaboration software” as used herein means software for synchronously working on data, documents, and files and for synchronously working with others, typically in distributed work groups, communities, and companies, on files, documents, tasks, projects and decisions, all in substantially real time.

### THE FIGURES

Various embodiments of out invention are illustrated in the Figures appended hereto.

FIG. 1 illustrates an application to create a data structure, here a white board, the creation of the data structure, and the DOM APIs.

FIG. 2 illustrates a server, the clients, the white boards, the white board objects, and the DOM APIs.

### DETAILED DESCRIPTION

The method, system, and program product described herein is a server-based, real time, collaboration system. The system uses open APIs.

The use of open APIs, with the DOM model, and, optionally, a standards based mark-up language, enables an application to keep data models in synch among distributed clients, and to do this in real time, using the existing DOM methods. That is, a developer modifies the DOM as if it was only local, but the changes are reflected at all clients “transparently”. Real time collaboration combined with real time synchronization is a synchronization process, and not a “check out-check in” system.

DOM as a means of real-time multipoint communications among distributed systems facilitates real time collaboration on such collaborative XML objects as white boards, presentation, agendas, spread sheet, documents, and the like. The system makes changes to a model in real time, and these changes are communicated to users in real time. The server monitors changes as changes are made by users.

APIs support modification of a data structure, such as a markup language document, and multiple workstations sharing a (virtual) database at multiple locations. Using the DOM API's, the DOM model can run a plurality of workstations. The workstations are connected to servers, including a virtual server, and a specific server in a group of servers. On the server, the data structure, for example, the shared data structure, is scoped to a specific namespace.

The database may be a shared (virtual) database, with the model on a plurality of workstations. Changes to the XML file occur in the shared document when an end user at one work-station modifies it. This is done using a (pre-defined) API to modify the data structure.

The server can use a mark up language, typically XML as a data model for the shared data, and DOM APIs to manipulate and monitor the model. The preferred markup language is XML because of the many common, pre-existing XML APIs to support manipulating shared XML documents and modification of XML documents.

The XML document encapsulates shared properties, which is one aspect of the XML dynamic data structure model. In the XML Data Model, this dynamic data structure model maps to a real time collaboration model.

The DOM APIs manipulate the XML Data Model. The combination of the XML Data Model and DOM provides a Shared XML that includes the capability for connecting to specific servers and for scoping to a specific namespace.

The interaction of shared XML and DOM transparently determines what data changes have been sent and how to synchronize the data, where the combination of Shared XML and DOM is a synchronization tool per se.

The Shared XML APIs are invoked in order to add new messages to a Shared XML document, as shown in the illustrative example below:

<ChatSession name=’chat1’>

<Message>

<Sender>Bill Quinn</sender>
<Test>Hi, how are you?</text>

</Message>
<Message>

<Sender>Matt Levy</Sender>
<Text>Fine, and you?</Text>

<Message>

</CharSession>

and, similarly,

<Whiteboard>

<Page name=”page1”>

<Annotation

type=’text’
x=’22’
y=’14’ ...>
Hello World

</Annotation>

</Page>

</Whiteboard>

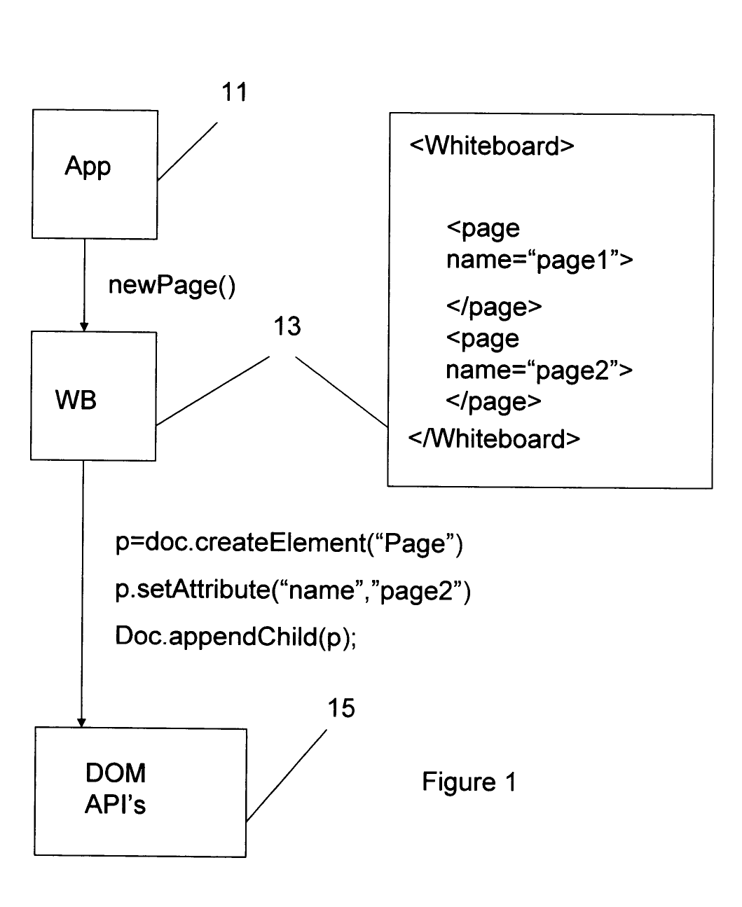

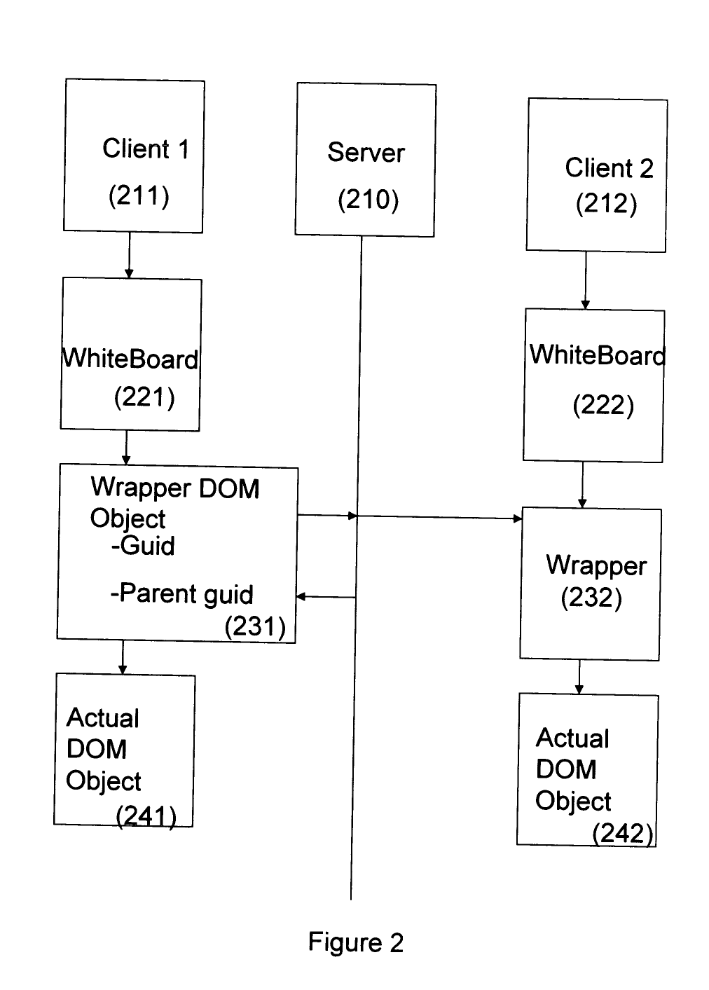

This is illustrated in FIGS. 1 and 2. FIG. 1 illustrates an application to create a data structure, here a white board, the creation of the data structure, and the DOM APIs. The Figure illustrates the application, 11, using the function newpage( ) to create a new page in the white board, 13, through the DOM APIs, 15, to create a new <Page> element in the document.

FIG. 2 illustrates a server, 210, the clients, 211, and 212, the white boards 221 and 222 the wrappers or containers for the white board objects, 231 and 232, and the DOM APIs, 241 and 242.

Shared XML APIs are wrappers over existing APIs. With the Shared XML APIs as wrappers over existing APIs, the Shared XML wrappers monitor intended changes to a doc or docs and the changes are sent as messages. These messages are communicated to the shared XML drivers, which reflect to all of the remote clients, where the wrapper monitors the intended changes. The changes are sent to the server to be implemented and sent to the workstations.

Shared XML is representative of a data structure where two clients have identical data structures where a background infrastructure is utilized to allow the data to span the multiple workstations. The shared data structure is a hierarchical structure where the API's, for example, the XML APIs plug into background infrastructure.

The DOM (Document Object Model) sets up a factory through wrapped DOMImplementation. In a wrapped DOMImplementation, the DomImplementation is the implementation from which shared documents are created. The shared document is used to create all other elements, as specified in the DOM API. The wrapped DOMImplementation includes the means for a client to subscribe to a server, where, as used herein, “Server” includes a server cluster, and a virtual server. The server has given namespace (e.g., “meeting.id”), as well as the capability of allowing a workstation end-user to subscribe to a specific set of Documents (by name), and also refreshing a late joiner. This is done through a complete document in a namespace and locking a document in a namespace.

A wrapped DOMImplementation allows multiple changes to occur in synchronized fashion. One aspect of this is that the DOM implementations allow applying batches of document manipulations as one atomic unit, that is, transactions.

Also included is the capability of indicating and recovering from manipulations that “fail” including a lack of locking. Because the program product wraps existing DOM nodes, failure is indicating by throwing an exception.

Wrapping or hooking of the underlying DOM implementation is done through “Nodes” where each node is an object in the object model. Sub-nodes can “inherit” in the Object Oriented Programming sense, where through “Inheritance” to sub-types of nodes (such as documents, elements of documents, and attribute of elements), where for each node in local DOM, a peer object in shared DOM, that is, the shared node wraps or contains the local node and uses it as delegate when operations occur.

One aspect of this is establishing a unique user id (UID) for each shared node, whereby a shared node is aware of a parent node's ID, a Document's UID and namespace.

With respect to detecting changes on one or more local workstations, detecting a change is carried out by first application calling a standard DOM API method on a node. The wrapper is aware of the manipulations to the data structure, as a file or document, and encodes the operation as it relates to nodes, Parent Nodes, Documents, and Namespaces. This is done by encoding changes detected on a local DOM. It is accomplished in a finite number of operations, as “Create node,” “Add node,” “Remove node,” “Change node value.” The messages to accomplish this are few and easy to decode. These messages are encoded on the client, and sent to server, where they are decoded, interpreted, and forwarded to the other clients.

If persistence is provided, the server applies the changes through remote (that is, from the individual workstations' perspective) manipulations to the DOM object. The server reflects changes to all of the subscribed clients. The clients decode a message, which includes necessary Node, Parent Node UID's. The message can be routed to the correct document, and then to the specific shared node where the manipulation is applied.

A Synchronization Entity or Engine on the server is associated with the shared data structure and synchronizes shared documents at all locations. An API is used to do this, and the local modifications are communicated to all similar applications at the different workstation locations.

The API sends a message indicating “detection” of change to the server. The API sends the changes on other local work stations to the server which applies the changes and modifications. The changes and modifications are communicated to all workstations, with a local copy to apply changes locally.

The server models for the persistent DOM state include a flattened relational list, in the form of two “tables.” One is a list of all documents, which includes namespace, document id, and transaction number. Documents are “locked” using this table. The lock can be on a single row.

The other table contains a list of the Document Nodes, that is, all of the nodes, including their parent nodes and their containing document. This is possible because all messages include UIDs for the namespace, the document, the parent node, and the node itself. The DOM state can be stored in a flat relational model, which makes the RDBMS model and tools applicable, and makes it possible to keep the DOMs state in RDBMS, which results in lower memory needs on a shared XML server.

A further aspect of the invention is that the shared XML server can be clustered for scalability. This avoids a single point of failure.

The combination of the DOM model and Shared XML also facilitates sequencing the order of transactions on the DOM server, where the server reflects operational changes to the DOM. In this way a single transaction is maintained per document, and the transaction id is sent to update messages to clients. The clients themselves have both the capability and the ability to order messages and to apply messages in the correct order. This gives the client workstations the ability to avoid “stale messages.”

The DOM-Shared XML system is independent of network architecture, and does not require Peer to Peer architecture.

While the invention has been described with respect to certain preferred embodiments and exemplifications, it is not intended to limit the scope of the invention thereby, but solely by the claims appended hereto.

1. A method of multiple work stations collaborating on a shared data structure stored on a server, the server being configured and controlled for multiple user access to and manipulation of shared data structures, said method comprising:
a. opening an application to access or create the shared data structure;
b. connecting to the server;
c. operating on the shared data structure on a remote work station;
d. invoking a wrapper for the changes to the shared data structure;
e. encapsulating the operations on the shared data structure into one or more messages;
f. sending the messages to the server;
g. entering the changes in the shared data structures on the server; and
h. reflecting the entered changes to other client work stations connected to the server.

2. The method of claim 1 wherein the method is carried out in real time.

3. The method of claim 1 wherein the shared data structure is chosen from the group consisting of conference white boards, presentations, agendas, spread sheets, and documents.

4. The method of claim 1 wherein the server is configured and controlled for multiple user access to and manipulation of shared data structures in accordance with the Document Object Model.

5 The method of claim 1 comprising connecting to the server through at least one API.

6. The method of claim 1 comprising connecting to the server and connecting to a namespace on the server associated to the shared data structure.

7. The method of claim 1 wherein the server monitors operations on the shared data structure on the work stations in real time.

8. The method of claim 7 comprising:
a. detecting a change in a data structure on a client work station; and
b. invoking a wrapper, encoding the operation.

9. The method of claim 1 comprising manipulating and modeling an XML mark-up language file in accordance with the Document Object Model.

10. The method of claim 9 wherein the shared data structure complies with an XML data model.

11. The method of claim 9 comprising synchronizing data structures to individual client work stations.

12. The method of claim 9 comprising creating DOM objects from a wrapped DOMImplementation application.

13. The method of claim 9 comprising applying a plurality of document changes as one atomic unit.

14. The method of claim 9 comprising wrapping underlying DOM applications in a wrapper as nodes.

15. The method of claim 14 wherein each node is an object in the DOM model.

16. The method of claim 15 wherein sub-nodes inherit from the nodes.

17. The method of claim 16 wherein the sub-nodes are chosen from the group consisting of documents, elements of a document, and attributes of an element.

18. The method of claim 17 wherein each node in a DOM file on a local work station is associated to an object in a shared node on the server.

19. The method of claim 18 wherein a shared node wraps a local node.

20. The method of claim 19 wherein each node has a unique user ID.

21. The method of claim 20 wherein the shared node is aware of parent node ID.

22. The method of claim 20 wherein the shared node is aware of the document ID.

23. The method of claim 20 wherein the shared node is aware of the namespace.

24. The method of claim 19 wherein a shared node wraps a local node.

25. The method of claim 21 wherein the local node uses the shared node as a delegate for operations.

26. The method of claim 1 comprising detecting a change by an application to the DOM model.

27. The method of claim 26 wherein the changes invoke a wrapper.

28. The method of claim 24 comprising detecting a change on a local DOM model, and encoding the detected change.

29. The method of claim 28 comprising encoding the detected change on the client, transmitting the detected change to the server, and implementing the change on the server.

30. The method of claim 29 comprising synchronously applying the change on the server and reflecting the change to the clients.

31. A program product comprising computer readable code to configure and control a collaborative process in a system comprising multiple work stations collaborating on a shared data structure stored on a server, the server being configured and controlled for multiuser access to and manipulation of the shared data structures, by a method comprising:
a. opening an application to access or create the shared data structure;
b. connecting to the server;
c. operating on the shared data structure a remote work station;
d. invoking a wrapper for changes to the shared data structure;
e. wrapping the operations on the shared data structure into one or more wrappers;
f. sending the wrapped changes to the server;
g. entering the changes in the shared data structure on the server;
h. reflecting the entered changes to other client work stations connected to the server.

32. The program product of claim 31 wherein the method is carried out in real time.

33. The program product of claim 31 wherein the shared data structure is a markup language file.

34. The program product of claim 33 wherein the markup language file is an XML file.

35. The program product of claim 33 wherein the mark-up language file is chosen from the group consisting of conference white boards, presentations, agendas, spread sheets, and documents.

36 The program product of claim 31 wherein the method comprises connecting to the server through at least one API.

37. The program product of claim 31 wherein the method comprises connecting to the server and connecting to a namespace on the server associated to the shared data structure.

38. The program product of claim 31 wherein the method comprises the server monitoring operations on the mark-up language file on the work stations in real time.

39. The program product of claim 38 comprising instructions for:
a. detecting a change in a data structure on a client work station; and
b. invoking a container, encoding the operation.

40. The program product of claim 31 wherein the method comprises manipulating and modeling the shared data structure in accordance with the Document Object Model.

41. The program product of claim 40 wherein the method comprises synchronizing data structures to individual client work stations.

42. The program product of claim 40 wherein the method comprises creating DOM objects from a wrapped DOMImplementation application.

43. The program product of claim 40 wherein the method comprises applying a plurality of document changes as one atomic unit.

44. The program product of claim 40 wherein the method comprises wrapping underlying DOM applications in containers as nodes.

45. The program product of claim 44 wherein each node is an object in the DOM model.

46. The program product of claim 45 wherein sub-nodes inherit from the nodes.

47. The program product of claim 46 wherein the sub-nodes are chosen from the group consisting of documents, elements of a document, and attributes of an element.

48. The program product of claim 47 wherein each node in a DOM on a local work station is associated to an object in a shared node on the server.

49. The program product of claim 48 wherein a shared node encapsulates a local node.

50. The program product of claim 49 comprising instructions for assigning each node has a unique user ID.

51. The program product of claim 50 wherein the shared node is aware of the parent node ID.

52. The program product of claim 50 wherein the shared node is aware of the document ID.

53. The program product of claim 50 wherein the shared node is aware of the namespace.

54. The program product of claim 53 comprising instructions for causing a shared node to wrap a local node.

55. The program product of claim 54 comprising instructions for causing a local node to use the shared node as a delegate for operations.

56. The program product of claim 31 comprising instructions for detecting a change by an application to the DOM model.

57. The program product of claim 56 wherein the changes invoke a wrapper.

58. The program product of claim 54 comprising instructions for detecting a change on a local DOM model, and encoding the detected change.

59. The program product of claim 58 comprising instructions for encoding the detected change on the client, transmitting the detected change to the server, and implementing the change on the server.

60. The program product of claim 59 comprising instructions for applying the change on the server, and reflecting the change to the clients.

61. A system including a server and a plurality of clients connected to the server for collaboration on a shared data structure stored on the server,
a. the server being configured and controlled for multiuser access to and manipulation of shared data structures,
b. the client being configured and controlled to
i. operate on the shared data structure at a remote work station;
ii. invoke a wrapper for the changes to the shared data structure;
iii. encapsulate the operations on the shared data structure into the wrapper; and
iv. send the encapsulated changes to the server;
c. the server being configured and controlled to
i. enter the changes in the shared data structure thereon; and
ii. reflect the entered changes to other clients connected to the server.

62. The system of claim 61 wherein the system operates in real time.

63. The system of claim 61 wherein the shared data structure is a markup language file.

64. The system of claim 63 wherein the markup language file is an XML file.

65. The system of claim 63 wherein the markup language file is from the group consisting of conference white boards, presentations, agendas, spread sheets, and documents, on the clients.

66. The system of claim 61 wherein the server associates a shared data structure to a namespace.

67. The system of claim 61 wherein the server:
a. monitors operations on the shared data structure at a client in real time;
b. detects changes in the shared data structure at the client; and
c. invokes a wrapper, and encodes the operation.

68. The system of claim 67 wherein the server is configured and controlled to manipulate and model the shared data structure in accordance with the Document Object Model.

69. The system of claim 68 wherein the server is configured and controlled to synchronize data structures to individual clients.

70. The system of claim 68 wherein the system is configured and controlled to create DOM objects from a wrapped DOMImplementation application.
